(19) United States
(12) Patent Application Publication
(10) Pub. No.: US 2011/0198898 A1
(43) Pub. Date: Aug. 18, 2011

(54) MOTORCYCLE SEAT DEVICE

(76) Inventor: Daniel Anthony Galati, Chesterfield, MO (US)

(21) Appl. No.: 12/707,086

(22) Filed: Feb. 17, 2010

(51) Int. Cl. B62J 1/14

(52) U.S. Cl. 297/195.13

(57) ABSTRACT

The present invention is a seat device mountable onto a motorcycle. The seat device includes a seat portion having a plurality of layers and a plurality of suction cups releaseably attachable to the seat portion. The plurality of suction cups can each have a screw, and the plurality of layers can include a layer having a plurality of threaded through-holes engageable with the screw of said suction cups. The plurality of layers can be bound together with a plurality of screw nails.

### CROSS-REFERENCE TO RELATED APPLICATIONS

Not Applicable.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention generally relates to accessories for motorcycles and more particularly to an attachable seat device for use with a motorcycle.

2. Related Art

Many motorcycles only have seats for drivers, without additional seats for additional persons. However, there can be a need for additional seats for additional persons to ride on.

There are seat devices attachable to motorcycles so as to provide additional seats. However, all of the present seat devices have advantages and disadvantages, and there is always a need in the art to provide a seat device attachable to a motorcycle that is ergonomically comfortable or efficient.

### SUMMARY OF THE INVENTION

The present invention presents a seat device mountable onto a motorcycle. The seat device has a seat portion having a plurality of layers and a plurality of suction cups releaseably attachable to the seat portion.

In a preferred embodiment, the plurality of suction cups can each have a screw, and the plurality of layers can include a layer having a plurality of threaded through-holes engageable with the screw of the suction cups. Preferably, the seat portion can have a binder for binding the plurality of layers together. The binder can be a plurality of screw nails.

The present invention also presents a seat device mountable onto a motorcycle. The seat device has a top seat cover, a form plate attached underneath the seat cover, and a form plate covering disposed underneath the form plate. The form plate has a plurality of threaded through-holes, and the form plate covering has a plurality of through-holes aligned with the plurality of threaded through-holes of the form plate. The seat device also has a plurality of suction cups disposed underneath the form plate covering. Each of the suction cups has a screw with a length substantially larger than the thickness of the form plate covering such that the screw of the suction cup can engage with the threaded through-holes of the form plate with the form plate covering sandwiched between the form plate and the suction cups. The through-holes of the form plate covering can be non-threaded.

In a preferred embodiment, the seat device further has a padding between the top seat cover and the form plate.

In a preferred embodiment, the number of the plurality of threaded through-holes of the form plate and the number of the plurality of through-holes of the form plate covering are the same, and no less than the number of the plurality of suction cups. Preferably, the number of the plurality of threaded through-holes of the form plate is ten, the number of the plurality of through-holes of the form plate covering is ten, and the number of the plurality of suction cups is six.

In a preferred embodiment, the seat device can further have a decorative plate disposed between the form plate covering and the suction cups. The decorative plate has a plurality of threaded through-holes aligned with the plurality of through-holes of the form plate covering. The seat device can further have a bottom covering disposed between the decorative plate and the suction cups. The bottom covering has a plurality of through-holes aligned with the plurality of threaded through-holes of the decorative plate. The seat device can further have a plurality of screw nails having a length substantially larger than the sum of the thickness of the bottom covering, the thickness of the decorative plate, and the thickness of the form plate covering such that the screw of the suction cup can engage with the threaded through-holes of the form plate with the bottom covering, the decorative plate, and the form plate covering sandwiched between the form plate and the suction cups.

Preferably, the decorative plate can have a back support portion. Alternatively or additionally, the decorative plate can have a tab with a through-hole for receiving a bolt.

In a preferred embodiment, the number of the plurality of threaded through-holes of the form plate, the number of the plurality of through-holes of the form plate covering, the number of the plurality of threaded through-holes of the decorative plate, the number of the plurality of through-holes of the bottom covering are the same, and no less than to the sum of the number of the plurality of suction cups and the number of the screw nails. The number of the plurality of threaded through-holes of the form plate can be ten, the number of the plurality of through-holes of the form plate covering can be ten, the number of the plurality of threaded through-holes of the decorative plate can be ten, the number of the plurality of through-holes of the bottom covering can be ten, the number of the plurality of suction cups can be six, and the number of the screw nails can be four.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a perspective view of a seat device according to an embodiment of the present invention;

FIG. 1B is an exploded view of the seat device of FIG. 1A;

FIG. 2A is a perspective view of a variant of the seat device of FIG. 1A;

FIG. 2B is an exploded view of the seat device of FIG. 2A;

FIG. 3A is a perspective view of another variant of the seat device of FIG. 1A;

FIG. 3B is an exploded view of the seat device of FIG. 3A;

FIG. 4A is a perspective view of yet another variant of the seat device of FIG. 1A; and

FIG. 4B is an exploded view of the seat device of FIG. 4A.

### DETAILED DESCRIPTION OF THE PREFERRED EMBODIMENTS

The following description of the preferred embodiment(s) is merely exemplary in nature and is in no way intended to limit the invention, its application, or uses.

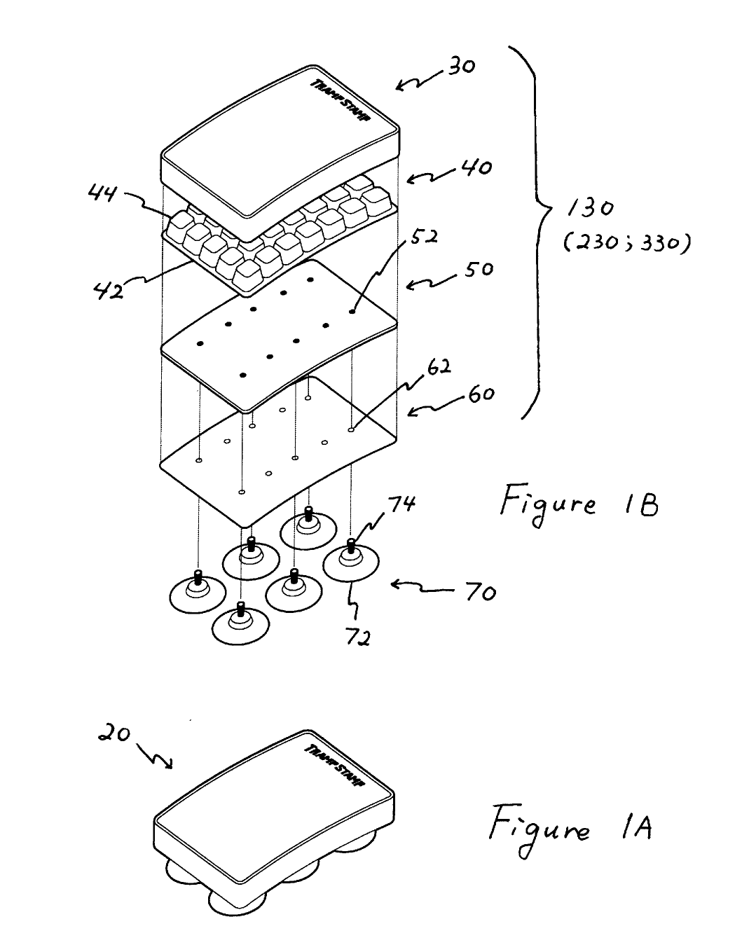

FIGS. 1A and 1B illustrate a seat device 20 according to the present invention. The seat device 20 can be attached to a motorcycle (not shown) to provide an additional seat for an additional person. Preferably, the seat device 20 can be attached onto a fender portion of the motorcycle. Preferably, the seat device 20 can be removeably attached to the motorcycle.

As seen in FIGS. 1A and 1B, the seat device 20 has a seat cover 30, a padding 40 disposed underneath the seat cover 30, a form plate 50 disposed underneath the padding 40, a form plate covering 60 disposed underneath the form plate 50, and six suction cups 70 disposed underneath the form plate covering 60. However, the seat device 20 can have a different number of suction cups 70.

The seat cover 30 can be made of leather, vinyl, and/or plastic material. Preferably, the seat cover 30 has a recessed portion on the bottom surface for receiving a portion of the padding 40.

The padding 40 has a padding base plate 42 and padding extrusions 44 extruding out of the padding base plate 42. When assembled with the seat cover 30, the padding extrusions 44 are disposed within the recessed portion of the bottom surface of the seat cover 30 and the padding base plate 42 closes the opening of the recessed portion of the bottom surface of the seat cover 30. The padding 40 can be glued to the seat cover 30 or otherwise fixed thereto.

The form plate 50 can be made of metal. The form plate 50 has ten threaded through-holes 52. However, the form plate 50 can have a different number of threaded through-holes 52. The form plate 50 can be glued to padding 40 and/or the seat cover 30 or otherwise fixed thereto.

The form plate covering 60 is in the form of a plate, and has ten through-holes 62. However, the form plate can have a different number of through-holes 62. When the form plate covering 60 is aligned with the form plate 50, the through-holes 62 of the form plate covering 60 are also aligned with their respective threaded through-holes 52 of the form plate 50.

Each of the suction cups 70 has a suction plate 72 and a screw 74. The screw 74 has a length such that it can go through the through-hole 62 of the form plate covering 60 and engage with the threaded through-holes 52 of the form plate 50. To complete the assembly of the seat device 20, the screws 74 of the six suction cups 70 respectively pass through six of the ten through-holes 62 of the form plate covering 60 and then engage with six of the ten threaded through-holes 52 of the form plate 50. The suction plates 72 can be used to removeably attach the seat device 20 to a fender portion of a motorcycle.

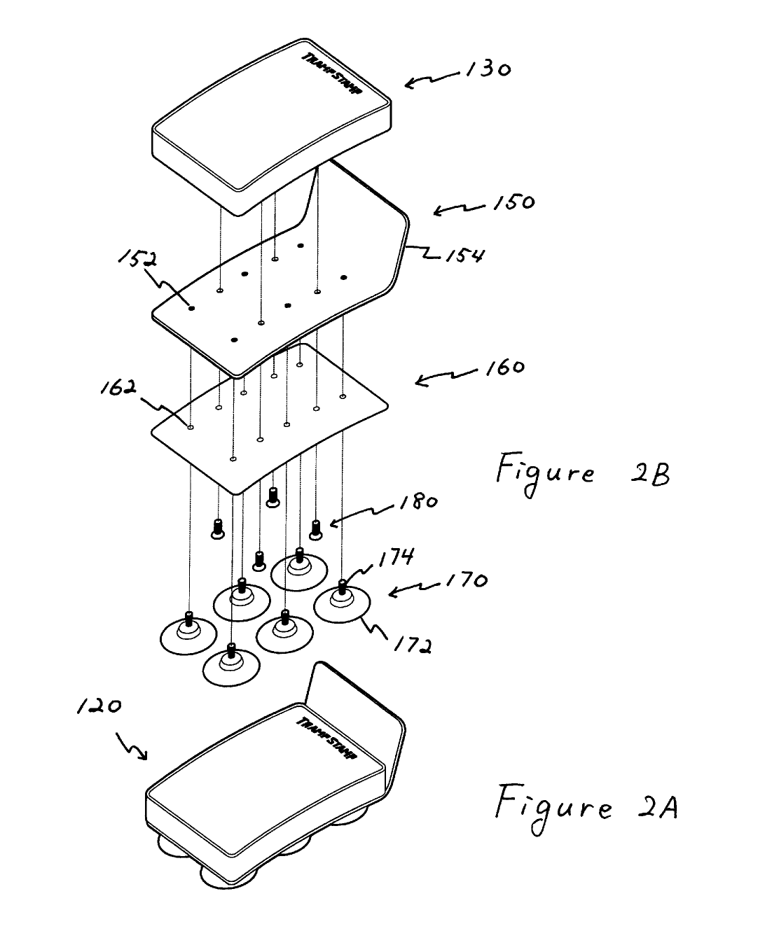

FIGS. 2A and 2B illustrate a seat device 120, which is a variant of the seat device 20 of FIGS. 1A and 1B. In this variant, a seat base unit 130 is used as a base unit for the seat device 120. The seat base unit 130 is composed of all the elements of the seat device 20 as seen in FIG. 1B except for the suction cups 70. Accordingly, the seat base unit 130 has a seat cover 30, a padding 40 glued or otherwise fixed underneath the seat cover 30, a form plate 50 glued or otherwise fixed underneath the padding 40, and a form plate covering 60 disposed underneath the form plate 50 as shown in FIG. 1B.

As seen in FIGS. 2A and 2B, the seat device 120 has the seat base unit 130, a decorative plate 150 disposed underneath the seat base unit 130, a bottom covering 160 disposed underneath the decorative plate 150, and six suction cups 170 disposed underneath the bottom covering 160. The seat device 120 also has four screw nails 180. However, the seat device 120 can have different numbers of suction cups 170 and screw nails 180.

The decorative plate 150 is formed identical with the form plate 50 except that the decorative plate 150 has a back support portion 154 at one end, as shown. This back support portion 154 can serve to support a back of a person sitting on the seat device 120. Like the form plate 50, the decorative plate 150 also has ten threaded through-holes 152, which can also be in a different number.

The bottom covering 160 is formed identical with the form plate covering 60. The bottom covering 160 is in the form of a plate, and has ten through-holes 162, which can also be in a different number. When the decorative plate 150 and the bottom covering 160 are aligned with the seat base unit 130, the threaded through-holes 152 of the decorative plate 150 and the through-holes 162 of the bottom covering 160 are aligned with each other, and with their respective through-holes 52 of the form plate 50 of the seat base unit 130 and threaded through-holes 62 of the form plate covering 60 of the seat base unit 130.

The screw nails 180 serve to assemble the decorative plate 150 and the bottom covering 160 with the seat base unit 130. Each of the screw nails 180 has a length such that it can go through the through-holes 162 of the bottom covering 160, then go through and engage with the threaded through-holes 152 of the decorative plate 150, then go through the through-holes 62 of the form plate covering 60 in the seat base unit 130, and then engage with the threaded through-holes 52 of the form plate 50 in the seat base unit 130.

The suction cups 170 are formed identical with the suction cups as shown in FIGS. 1A and 1B. Each of the suction cups 170 has a suction plate 172 and a screw 174. The screw 174 has a length such that it can go through the through-hole 162 of the bottom covering 160 and engage with the threaded through-holes 152 of the decorative plate 150. This way, the suction cups 170 can be fixed to the other portions of the seat device 120. The suction plates 172 can be used to removeably attach the seat device 120 to a fender portion of a motorcycle.

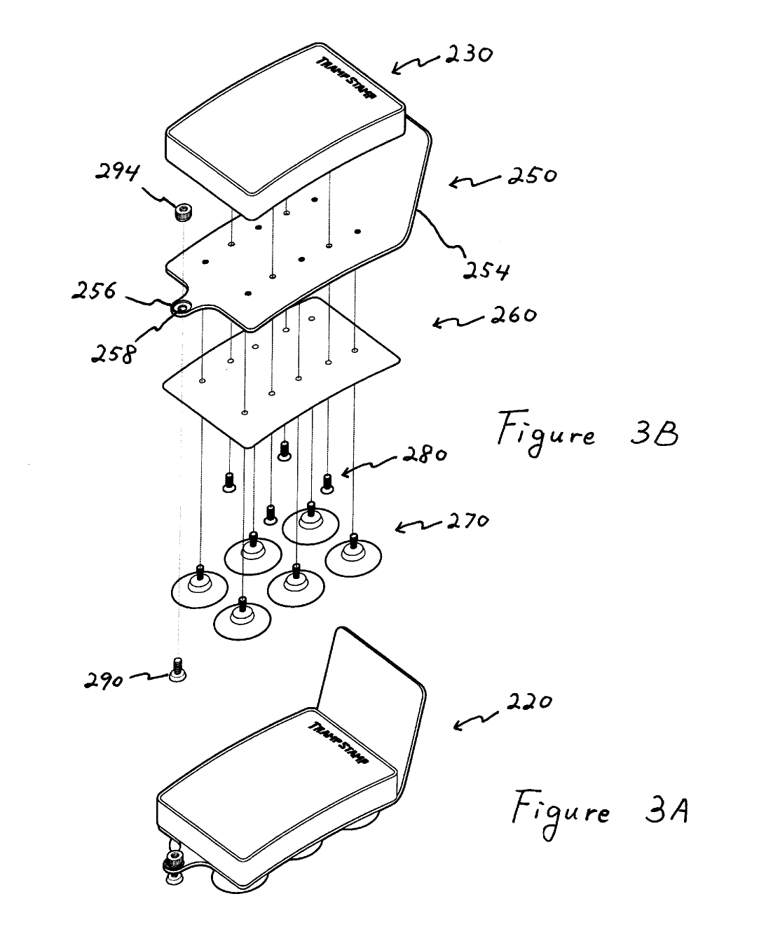

FIGS. 3A and 3B illustrate a seat device 220, which is another variant of the seat device 20 of FIGS. 1A and 1B. The seat device 220 has a seat base unit 230, a decorative plate 250, a bottom covering 260, six suction cups 270, and four screw nails 280. The seat device 220 shown in FIGS. 3A and 3B is identical with the seat device 120 shown in FIGS. 2A and 2B except that the decorative plate 250 has a higher back support portion 254 at one end and a tab 256 at the opposite end. The tab 256 is an extended portion extruding outwardly, and has an additional through-hole 258. A pair of bolt 290 and nut 294 can be used to provide additional security by attaching the decorative plate 250 to the fender portion of the motorcycle.

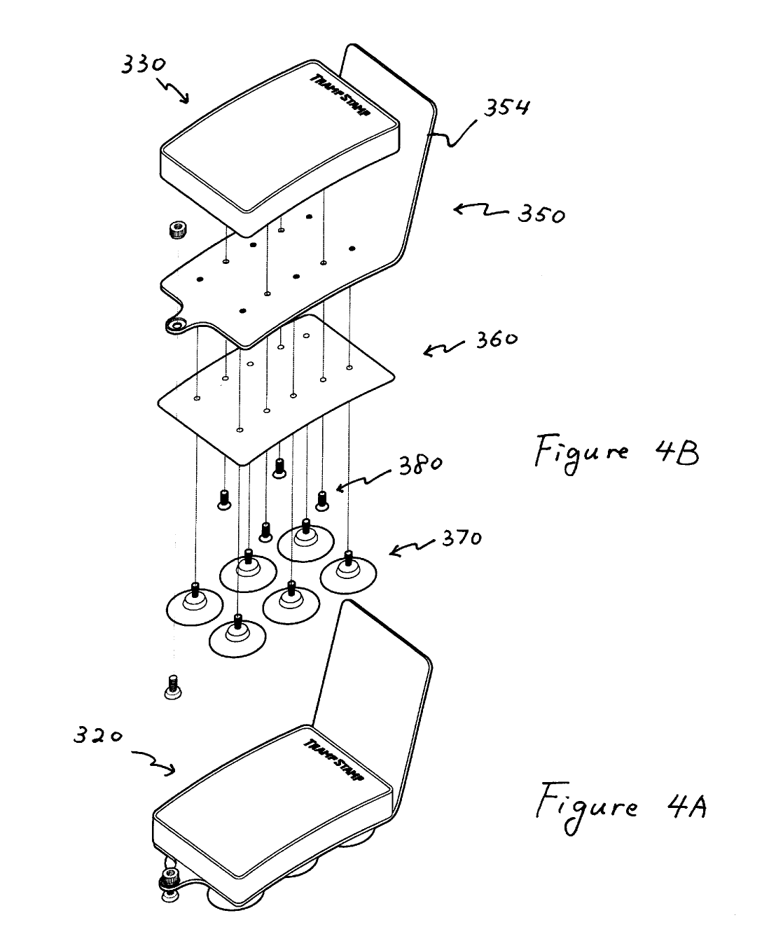

FIGS. 4A and 4B illustrate a seat device 320, which is yet another variant of the seat device 20 of FIGS. 1A and 1B. The seat device 320 has a seat base unit 330, a decorative plate 350, a bottom covering 360, six suction cups 370, and four screw nails 380. The seat device 320 shown in FIGS. 3A and 3B is identical with the seat device 220 shown in FIGS. 3A and 3B except that the decorative plate 350 has a much higher back support portion 354.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A seat device mountable onto a motorcycle, comprising:
a top seat cover;
a form plate attached underneath said top seat cover, said form plate having a plurality of threaded through-holes;
a form plate covering disposed underneath said form plate, said form plate covering having a plurality of through-holes aligned with said plurality of threaded through-holes of said form plate;
a plurality of suction cups disposed underneath said form plate covering, each of said suction cups having a screw with a length substantially larger than the thickness of said form plate covering.

2. A seat device according to claim 1, further comprising:
a padding disposed between said top seat cover and said form plate.

3. A seat device according to claim 1, wherein the number of said plurality of threaded through-holes of said form plate and the number of said plurality of through-holes of said form plate covering are the same, and no less than the number of said plurality of suction cups.

4. A seat device according to claim 1, wherein the number of said plurality of threaded through-holes of said form plate is ten, the number of said plurality of through-holes of said form plate covering is ten, and the number of said plurality of suction cups is six.

5. A seat device according to claim 1, wherein said through-holes of said form plate covering are non-threaded.

6. A seat device according to claim 1, further comprising:
a decorative plate disposed between said form plate covering and said suction cups, said decorative plate having a plurality of threaded through-holes aligned with said plurality of through-holes of said form plate covering;
a bottom covering disposed between said decorative plate and said suction cups, said bottom covering having a plurality of through-holes aligned with said plurality of threaded through-holes of said decorative plate; and
a plurality of screw nails having a length substantially larger than the sum of the thickness of said bottom covering, the thickness of said decorative plate, and the thickness of said form plate covering.

7. A seat device according to claim 6, wherein said decorative plate has a back support portion.

8. A seat device according to claim 6, wherein said decorative plate has a tab with a through-hole for receiving a bolt.

9. A seat device according to claim 6, wherein the number of said plurality of threaded through-holes of said form plate, the number of said plurality of through-holes of said form plate covering, the number of said plurality of threaded through-holes of said decorative plate, the number of said plurality of through-holes of said bottom covering are the same, and no less than to the sum of the number of said plurality of suction cups and the number of said screw nails.

10. A seat device according to claim 6, wherein the number of said plurality of threaded through-holes of said form plate is ten, the number of said plurality of through-holes of said form plate covering is ten, the number of said plurality of threaded through-holes of said decorative plate is ten, the number of said plurality of through-holes of said bottom covering is ten, the number of said plurality of suction cups is six, and the number of said screw nails is four.

11. A seat device mountable onto a motorcycle, comprising:
a seat portion having a plurality of layers; and
a plurality of suction cups releaseably attachable to said seat portion.

12. A seat device according to claim 11, wherein each of said plurality of suction cups has a screw, and wherein said plurality of layers comprise a layer having a plurality of threaded through-holes engageable with said screw of said suction cups.

13. A seat device according to claim 12, wherein said seat portion has a binder for binding said plurality of layers together.

14. A seat device according to claim 13, wherein said binder comprises a plurality of screw nails.
